(19) United States
(12) Patent Application Publication
(10) Pub. No.: US 2021/0092610 A1
(43) Pub. Date: Mar. 25, 2021

(54) METHOD FOR DETECTING ACCESS POINT CHARACTERISTICS USING MACHINE LEARNING

(71) Applicant: SAMSUNG ELETRÔNICA DA AMAZÔNIA LTDA., CAMPINAS (BR)

(72) Inventor: EDUARDO KUGLER VIEGAS, CAMPINAS - SÃO PAULO (BR)

(73) Assignee: SAMSUNG ELETRÔNICA DA AMAZÔNIA LTDA., CAMPINAS (BR)

(21) Appl. No.: 16/790,007

(22) Filed: Feb. 13, 2020

(30) Foreign Application Priority Data
Sep. 25, 2019 (BR) 10 2019 020060 0

(51) Int. Cl. H04W 12/12; H04L 12/26; H04L 12/24; H04W 48/02; G06N 20/00

(52) U.S. Cl. CPC H04W 12/1201; H04L 43/04; G06N 20/00; H04W 48/02; H04L 41/16

(57) ABSTRACT

The present invention relates to method for detection of access point characteristics based on machine learning methods to passively recognize and classify W-Fi Access Points (AP) characteristics before establishing a connection. The method passively extracts behavior features based on the message received from the AP, e.g., a beacon frame, which can then be used for classification and recognition purposes. For classification, the technique enables the separation of APs into categories, e.g., hardware-based and software-based devices, thus, allowing the detection of fake APs, improving user's security. Finally, when used for recognition purposes, the technique enables the identification of the AP type, e.g. identify if the AP is a router, printer, camera, hotspot, the software used for software-based AP, or others, which, consequently can be used to assess the AP trustworthiness before a connection can be reliably established.

### CROSS-REFERENCE TO RELATED APPLICATIONS

This application claims the benefit of Brazilian Application No. 10 2019 020060 0, filed Sep. 25, 2019, in the Brazilian Intellectual Property Office, the disclosure of which is incorporated herein by reference.

### BACKGROUND

### 1. Field

The present patent is related to wireless communication technology field. More specifically, it describes a way to passively classify and recognize access points (AP) characteristics. The classification process assigns a given AP as belonging to a preset of classes. Therefore, for example, it enables labeling an AP as either hardware-based or software-based device, aiding the identification of possible malicious APs. On the other hand, the recognition process seeks the identification of the AP type, e.g. router, printer, camera, hotspot, etc. Hence, the present invention, by the means of detecting AP characteristics improves user security through the classification and recognition of AP characteristics. Therefore, security solutions can use the AP characteristics to assess its trustworthiness, before the connection is established. In this document, for ease of understanding, are provided scenarios where the invention can be applied. For the sake of simplicity, we consider the IEEE 802.11 WLAN network scenario, in which a user connects to an AP that replies to client broadcast messages.

The present invention relates to a method for detecting access point characteristics using machine learning based on machine learning methods to passively recognize and classify W-Fi Access Points (AP) characteristics before establishing a connection. The method passively extracts behavior features based on the message received from the AP, e.g., a beacon frame, which can then be used for classification and recognition purposes. For classification, the technique enables the separation of APs into categories, e.g., hardware-based and software-based devices, thus, allowing the detection of fake APs, improving user's security. Finally, when used for recognition purposes, the technique enables the identification of the AP type, e.g. identify if the AP is a router, printer, camera, hotspot, the software used for software-based AP, or others, which, consequently can be used to assess the AP trustworthiness before a connection can be reliably established.

### 2. Description of the Related Art

Nowadays, most connected devices relies on wireless communication channels to exchange information. In such context, devices such as smartphones and Smart TVs, in general send and receive data over wireless local area network (WLAN) by the means of the IEEE 802.11 standard family. In IEEE 802.11, a device connects to a W-Fi access point (AP), usually after an authentication process, and exchanges data during the connection. Before performing the authentication process, devices usually send probe requests to nearby APs, which in turn, reply with a proper probe response containing information pertaining the AP features, capabilities, SSID, among others. To allow users to be aware of nearby access points, client devices often send periodic probe requests to search for known APs, hence, automatically connecting to known nearby APs.

Wireless communication channels are prone to a wide range of attacks due to IEEE 802.11 architectural design. For instance, an attacker can easily spoof probe responses from a benign AP using software-based APs to act as a known device, luring clients to connect to potentially malicious APs. Furthermore, an attacker can even disconnect clients authenticated to a benign AP by forging disconnection messages and force them to connect to a malicious software-based AP.

On the other hand, when travelling, mobile device users often connect to public wireless APs for Internet access. Because of the easiness of setting up a fake AP using software-based solutions, attackers often lure users to connect to their malicious AP by setting their SSID as “Free Internet Wi-Fi” or even using names from well-known public stores. Thus, when a device connects to a malicious AP he is subject to all sort of attacks, such as connection eavesdropping, download of malicious content, redirection to malicious website, stealing of credentials, among others.

Surprisingly, device users are unable to identify these kinds of attacks. As result, before the AP connection is established, users are unaware of any type of AP characteristic besides the AP SSI D. Therefore, when the attacker sets a fake AP, usually through software-based solutions, the user does not know that such device may be malicious. Consequently, attacks such as setting a software-based AP for information stealing are becoming a common practice nowadays. Nonetheless, several tools enable these attacks with only a small set of commands, or even through a graphical user interface. Hence, requiring little or no knowledge by the attacker, while the user remains unaware of this potential threat.

On the other hand, in general, when searching for nearby APs, current security solutions do not use any kind of AP characteristic besides the SSID to assess which AP should be used for connection. For instance, a device may prefer to connect to hardware-based APs instead of software-based devices. Nonetheless, when several nearby APs have the same SSID name, security solutions often rely in the BSSID value as an attempt to gather AP characteristics. Therefore, current security solutions still lack better understanding of AP characteristics, such as, if the AP is a hotspot, or if it is running based on an access point software, such as hostapd, aircrackng, connectify, etc.

Detection of Access Point characteristics is still in its beginnings. In general, authors are concerned with the detection of Rogue W-Fi Access Points, in which a malicious access point is disguised as a benign one.

The patent document US2018205749 A1 entitled, “DETECTING A ROGUE ACCESS POINT USING NETWORK-INDEPENDENT MACHINE LEARNING MODELS”, by QUALCOMM Incorporated, filed on Jan. 18, 2017, describes a method for detecting Rogue Access Points using machine learning methods. The patent comprises the computation of delta-features from access points obtained by calculating the differences between several feature measurements. Then, the feature set is fed to a machine learning algorithm for identification of deviations between the expected access point profile.

Differently from the present invention, the patent document US2018205749 A1 focuses on detecting Rogue Access Points using machine learning techniques, while the present invention detects access point characteristics, for classification and recognition purposes.

The patent document US 2010142709 A1 titled, “ROGUE ACCESS POINT DETECTION IN WIRELESS NETWORKS”, by ALCATEL, filed on Feb. 19, 2010, describes a method for the detection of Rogue Access Points with respect to its location. The invention technique gathers AP location reports from several mobile stations and detect possible location inconsistencies.

Differently from the present invention, the mentioned patent extracts the access point behavior according to its location. In contrast, the method of the present invention extracts the access point behavior based on its generated messages. Nonetheless, the patent document US2010142709 A1 demands that each mobile station reports the found AP locations, while the method of the present invention is performed within the client device, without demanding changes in protocols neither the transmission of additional messages over wireless link;

The patent document US20160192136 A1 titled, “IDENTIFICATION OF ROGUE ACCESS POINTS”, by INTEL CORPORATION, filed on Jul. 19, 2013 also describes a method for detecting Rogue Access Points with respect to its location. The present invention relies on a reference location of each access point thus, rogue access points are identified according to the differences between its expected location and its current location.

Differently from the present invention, the patent document US20160192136 A1 extracts the access point behavior according to its location. In contrast, the method of the present invention extracts the access point behavior based on the generated messages. Nonetheless, US20160192136 A1 relies in knowing previously the access point reference location, while the present invention is performed within the client device, without any prior knowledge;

The patent document KR101606352 B1 titled, “SYSTEM, USER TERMINAL, AND METHOD FOR DETECTING ROGUE ACCESS POINT AND COMPUTER PROGRAM FOR THE SAME”, by SEEDGEN CO LTD, granted on Mar. 28, 2016, describes a method for detecting Rogue Access Points with respect to its behavior after a connection is established, creating a database with Access Point features, which may comprise information such as SSID, password, hops to gateway, hash of management website, among others. Rogue access point is detected when deviations are found.

Differently from the present invention, the patent document KR101606352 extracts the access point behavior after a connection is established. In addition, several features are extracted by the means of sending messages over the wireless link. In contrast, the technique described herein extracts, using a passive approach, the access point behavior based on its generated messages. Nonetheless, document KR101606352 demands a database which holds the access point behaviors, while the method of the present invention models each access point behavior by machine learning means;

The patent document U.S. Pat. No. 7,808,958 B1 titled, “ROGUE WIRELESS ACCESS POINT DETECTION”, by Symantec Corporation, granted on Oct. 5, 2010, describes a method for detecting Rogue Access Points with respect to its fingerprint. The invention relies in a centralized computing endpoint, which detects duplicate access points' fingerprints.

Differently from the present invention, the patent document U.S. Pat. No. 7,808,958 B1 extracts the access point behavior by generating a unique fingerprint. The fingerprint, according to their specification, is extracted using beacon frames sent by access points, which includes the AP IP address among other features. Therefore, although said method extracts AP fingerprint in a passive manner, patent document U.S. Pat. No. 7,808,958 B1 access point profile cannot be used for detection of access point characteristics, hence it is based on network features, rather than AP capabilities;

The patent document U.S. Pat. No. 7,676,216 B2 titled, “DYNAMICALLY MEASURING AND RE-CLASSIFYING ACCESS POINTS IN A WIRELESS NETWORK”, by Cisco Technology, Inc., granted on Mar. 9, 2010, describes a method for the periodic detection of Rogue Access Points. The method relies on a database for the storage of friendly, rogue and managed access points. Periodically, the stored access points are queried and evaluated.

Differently from the present invention, the patent document U.S. Pat. No. 7,676,216 B2 extracts the access point behavior based on the measured features differences over time. In addition, patent document U.S. Pat. No. 7,676,216 technique demands a database for the storage of friendly, rogue and managed access points, therefore relying in a centralized entity for the detection task. In contrast, the present invention can be performed in the client device, whilst the detection features are obtained in a single access point message.

The patent document U.S. Pat. No. 9,913,201 B1 titled, “SYSTEMS AND METHODS FOR DETECTING POTENTIALLY ILLEGITIMATE WIRELESS ACCESS POINTS”, by Symantec Corporation, granted on Mar. 6, 2018 describes a method for the detection of illegitimate wireless access points. Said document U.S. Pat. No. 9,913,201 detects Rogue Access Points by the means of the geographic location by the time that the client device connects to it.

Differently from the present invention, the patent document U.S. Pat. No. 9,913,201 B1 focuses on the detection of illegitimate access points relying on geographical-based features. In contrast the present invention detects access points characteristics, that could be employed for detection of Rogue Access Points, by the means of the messages sent from it.

Current market solutions are still unable to detect access point characteristics. Therefore, client devices are exposed to a variety of threats and lack of better understanding regarding the AP behavior. Thus, in the last years some security solutions were developed to improve user security regarding the wireless AP that it connects to.

CISCO Adaptive Wireless IPS Software technologies is a technology that may be close to the present invention (https://www.cisco.com/c/en/us/products/wireless/adaptive-wireless-ips-software/index.html). A wireless intrusion prevention system released by CISCO company. CISCO proposal enables the detection of several wireless attacks including Rogue Access Point, Hotspot, among others. According to their deployment guide, the detection of Rogue Access Points is achieved by trough a whitelist, containing the benign access points. On the other side, the detection of hotspots is not detailed, however, the detection made by current security solutions is achieved either by: (1) a prior defined list of MAC addresses used by smartphone developer companies, or (2) a metering flag sent in DHCP responses. CISCO solution is primarily designed for enterprise environments. In contrast, the present invention can be used in both enterprise and domestic environments, as it can be readily embedded in wireless-enabled devices. In addition, CISCO solution demands a centralized entity for configuration purposes, while the present invention does not require any infrastructure designated to it. The solution currently being sold by CISCO shows that the present invention is still not being used by our competitors, this because CISCO solution demands policies to be configured for the detection task.

Another solution that may be close to the present invention is W-Fi Direct. W-Fi Direct networks already enable the detection of the access point types, e.g. camera, smartphone, Smart-TV, among others. Wi-Fi Direct detection features is already implemented in wireless devices, for example, an icon device type is shown in the graphical user interface of smartphones. However, this feature is only available when using Wi-Fi Direct, because probe responses coming from Wi-Fi Direct devices contain the access point type. Unfortunately, Wi-Fi Direct is only used when connecting in a peer-to-peer network, which is in general used to share data between two devices. For example, a smartphone sending a picture to a Smart-TV. The present invention enables Wi-Fi products to provide the same feature as Wi-Fi Direct devices. In other words, to detect the AP type before a connection is established;

Android detection of hotspots is also a technology that may be close to the present invention. Current implementation for the detection of hotspots in Android devices relies on a flag sent in DHCP reply messages. In other words, it checks whether the DHCP lease has a metered flag set. Therefore, this detection can only be made after a connection is established. The present invention enables Wi-Fi products to detect hotspots before a connection is established. In addition, it does not require checking for DHCP flags, since machine learning techniques are applied in access point broadcasted messages;

The present invention enables products to detect hotspots before establishing a connection, regardless of the company that manufactured the device. In addition, differently from prior art solutions, products using the present invention can detect nearby devices regardless of their type, whether they are a smartphone, router, SmartTV or others, this occurs because the technique used in the present invention is able to detect several types of wireless devices.

### SUMMARY

The present invention process begins with a client that wishes to assess nearby APs reliability before establishing a connection. To fulfill such goal, the client device may either broadcast a message to nearby APs or passively listen to nearby APs messages, e.g., beacon frames. Afterwards, nearby APs reply such message with a proper corresponding reply message, while in the former, APs periodically broadcast messages announcing their presence to nearby clients. The client device, when receiving the AP message, extracts a feature vector. The feature vector then acts as a representation of the AP behavior. Consequently, the AP behavior is used for the classification and recognition process. When used for classification purposes, the client device relies in the AP behavior to classify it into a given category. For this purpose, the client device applies machine learning models, trained with a preset of AP categories. Therefore, the assigned class is used to assess the AP reliability, e.g. an AP labeled as software-based indicates a possible malicious AR. On the other hand, when used for recognition purposes the client device uses the AP behavior to assign it to a given set of AP types. For this purpose, the client also relies on machine learning schemes. Here, the assigned class obtained during classification and the type obtained during recognition improve user security, e.g. security solutions can detect if an AP is a router, printer, hotspot, mobile device, among others. Therefore, the AP characteristics, established during the classification and recognition process, can be employed to assess the AP trustworthiness before the user even establishes a connection. This way, this invention provides a method to passively establish nearby APs features, hence, significantly improving user security.

The method proposed in the present invention can be applied to most products with wi-fi connection, such as smartphones, Smart TVs, among others. In addition, no hardware changes are required for the identification, classification, and recognition tasks. Finally, the invention is lightweight and can be embedded in resource constrained devices, such as wearable devices, with little or no battery impact.

### BRIEF DESCRIPTION OF THE DRAWINGS

The objectives and advantages of the current invention will become clearer through the following detailed description of the example and non-limitative drawings presented at the end of this document:

FIG. 1 presents the invention typical application scenario.

FIG. 2 presents the proposed invention information flow between its modules.

FIG. 3 presents the flowchart of the proposed access point characteristic detection method.

FIG. 4 presents an example of a feature vector extracted from an access point message.

### DETAILED DESCRIPTION

The drawings will be described in detail with mention to the reference numbers, whenever possible. The specific examples used throughout the description are used only for clarification purposes and are not intended to limit the applicability of the present invention.

The term “access point” is used herein to refer to a wireless communication device that enables client devices to have access to a network. Example of access points include but are not limited to wireless routers, switches, smartphones, printers, among others.

The term “access point characteristic” is used herein to refer to a property from the access point, in which its clients desire to detect for security purposes or not. Examples of access points characteristics include but are not limited to: if the AP is hardware-based; if the AP is software-based; if AP is software-based which software was used for its setup; if the AP is a hotspot; the AP type, such as router, printer, camera, Smart-TV, smartphone, among others.

The term “wireless-based communication device” is used herein to refer to a device that connects to an access point via wireless communication link. Therefore, in a typical scenario, the proposed invention is executed in the wireless-based communication device to detect the access point characteristics before a connection is established. Examples of wireless-based communication device include but are not limited to smartphones, notebooks, smart-TVs, smartwatches, cameras, routers, security appliances, among others.

The term “feature” is used herein to refer to a property extracted from a message transmitted from an access point. The feature may be extracted directly from the property included in the access point message or extracted by the processing of several properties included in the access point message. For example, in 802.11 protocol family a set of features may be extracted from a beacon message, wherein a feature comprises a specific field from such message. As another example, a feature may also comprise an information regarding the presence or not of specific fields from a given AP message.

The term “recognizer” is used herein to refer to a machine learning algorithm that identifies similarities between its input and a set of known examples. The recognizer may rely on clustering, classification, distance-based or other machine learning techniques. For example, a recognizer may use a distance-based algorithm to return the most similar access point characteristic for a given input.

The term “classifier” is used herein to refer to a machine learning algorithm that classifies an input into a class. The class refers to a group of examples that presents the same properties. For example, a classifier may label an input as either software-based or hardware-based AP, in such a case the property is whether the AP is a hardware-based device or software-based device. As another example, a classifier may label an input as either hotspot or not hotspot AP.

### New Features of the Invention

Current security solutions for wireless-enabled devices are not able to obtain meaningful characteristics of nearby access points (AP). Therefore, devices are exposed to a broad range of attacks, as detection techniques lack a better understanding about the AP behavior. Consequently, this invention tackles the security gap when devices want to connect to nearby APs. This occurs because the present invention enables security solutions to obtain a wider range of AP characteristics before a connection is established with the AP. Hence, security solutions can better evaluate the characteristics to assess the AP trustworthiness, thus, improving user security. To achieve such goal, the present invention passively classifies and recognizes access points (AP) characteristics according to the messages sent before a connection is established.

Once all the steps are successfully completed, the method of the present invention provides the device enriched information regarding the AP characteristics. As an example, the method of the present invention can detect nearby hardware-based or software-based APs, serving as an indication that an attack may be occurring, for example, detect a software-based AP that owns a known SSI D from a trusted commercial or corporative AP from a major vendor. The method of the present invention also adds the possibility of detecting the software used to set up an AP when applicable, e.g. APs created using aircrackng, hostapd, connectify software or even configured using a smartphone hotspot. Nonetheless, the invention also enables the detection of the AP type, e.g. router, printer, camera, smartphone, among others.

Therefore, when using the present invention, products will be able to detect a wider range of suspicious APs by the means of the obtained AP characteristics.

### Advantages of the Invention

The present invention detects AP characteristics using a passive approach, without requiring modifications in the communication protocols. Therefore, nearby APs are not able to detect when the present invention is in execution in a device. In addition, commonly used wireless protocols (e.g. IEEE 802.11 protocol family) already define a series of messages that must be periodically broadcasted by APs (e.g. beacons), even before a connection is made. Hence, no changes in protocol neither the transmissions of network packets are required by the device.

The present invention can determine which nearby AP is running in a software-based approach. Hence, it improves user security, because, in general, APs running with malicious purposes are configured by software means, e.g. using aircrackng, or hostapd software.

The present invention can establish, when applicable, which software was used for setting up the software-based AP. For instance, when a software-based AP is detected, the proposed invention can detect whether it is running using aircrackng, hostapd, connectify, among others. Thus, current security solutions may rather connect to nearby software-based AP that was setup with non-traditional tools commonly used for malicious purposes.

The present invention can detect nearby hotspot APs created by a smartphone. Hence, this information can be used to improve user security. In general, mobile hotspots are not used for malicious purposes, thus can be reliably connected.

The present invention can detect hardware-based AP. Thus, this characteristic can assess the AP reliability, as, in general, hardware-based APs are not used for malicious purposes.

The present invention can detect a variety of AP types, such as printers, cameras, smartphones, hardware-based, and software-based APs, among others. This information can be used to assess the AP reliability before a connection is made, improving user security.

The present invention does not require a dedicated hardware to fulfill its goals. The detection process can be readily embedded in resource-constrained devices with little or no battery impact. This occurs because the detection is made by software, requiring only access to messages broadcasted by nearby access points (AP).

The present invention detects AP characteristics using a single message. Therefore, it greatly decreases the processing demands. The only requirement of the invention is that such message includes the AP capabilities, e.g. the fields included in IEEE 802.11 beacon and probe response messages.

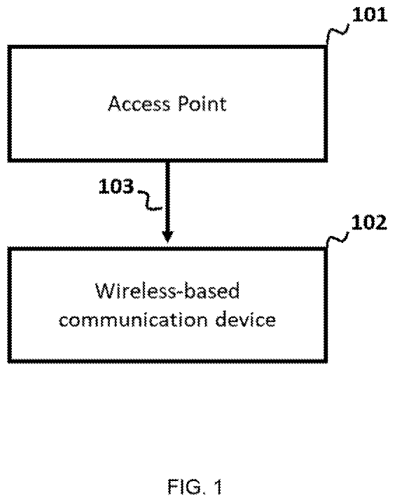

An application scenario of our invention is shown in FIG. 1. The scenario includes an access point (101) and a wireless-based communication device (102). The access point communicates with the wireless-based communication device using a wireless communication link. Both devices communicate via a common and shared protocol, such as 802.11 protocol family, for example 802.11a/b/g/n/ac/ax among others. The wireless-based communication device listens for messages (103) sent from nearby access points. The access point messages can be sent periodically or only after a stimulus is received. For example, in IEEE 802.11 protocol family, an access point periodically broadcasts beacon messages, on the other hand, it also includes messages to be generated after a stimulus, such as the probe responses, which are generated after a probe request is received. It is a requirement of the proposed invention that the messages used for the execution of the detection method include the access point information pertaining the AP capabilities. An example of such messages includes but is not limited to IEEE 802.11 beacon messages, and IEEE 802.11 probe responses.

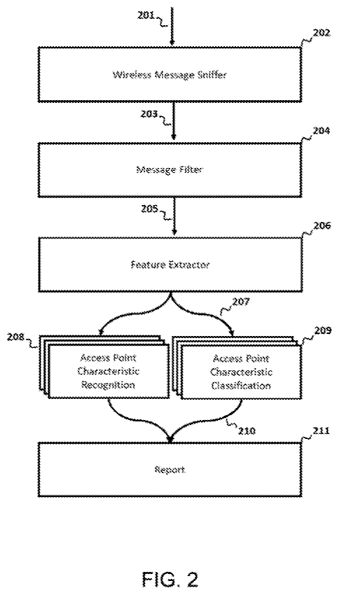

FIG. 2 illustrates the proposed invention information flow after an access point message is received. The proposed invention is executed in a wireless-based communication device. The information flow begins with a message (201) received from the monitored environment. The message is obtained by a wireless message sniffer (202), which monitors the messages received by the wireless-based communication device. Afterwards, the received message is forwarded (203) to the message filter module (204). The message filter module aims to establish which received messages can be used to extract the access point characteristics. Therefore, the message filter module must be able to properly interpret network protocols and detect when the desired messages are received. The message filter module must properly discard messages that are not used for neither classification nor recognition tasks. Examples of desired messages that can be used for classification or recognition task include but are not limited to IEEE 802.11 beacon message and IEEE 802.11 probe responses message. The selected messages are then forwarded (205) to a feature extractor module (206).

The feature extractor module, based on the selected message, extracts a set of features used for classification and/or recognition purposes. Hence, the feature extractor module must be able to interpret the desired message network protocol. The feature extractor module, for each feature that compounds the feature set, performs the extraction of the message field or computation process required to its extraction. When a feature can be extracted directly from a message field, the feature extractor copies the message field value to its corresponding index of the feature set. In contrast, when a computation is required for the extraction of a feature value, the feature extractor module performs the required computation and copies the corresponding result to its related index in the feature set. An example of features that can be directly extracted from message fields include but are not limited to: flag values, capability values, vendor values, among others. As an example of features that may require additional computation for its extraction includes but are not limited to: number of occurrences of a given field, total size of a given field, presence of a given field, among others. After the extraction of all features, the feature set is forwarded (207) to the access point characteristic recognition module (208) and access point characteristic classification module (209).

The access point characteristic recognition module receives as input a feature set and output a related access point characteristic. To fulfill its goal, the access point characteristic recognition module applies a machine learning model that recognizes similarities between its input and a set of known examples. The recognizer may rely on clustering, classification, distance-based or other machine learning techniques. For example, a recognizer may use a distance-based algorithm to return the most similar access point characteristic for a given input. Before the message enters the machine learning module, the access point characteristic recognition module translates the feature set for a proper machine learning input. As an example, the feature set translation may comprise none, all, or other of the following tasks: normalization, standardization, feature selection, feature reduction, among other pre-processing techniques. For instance, before applying a distance-based machine learning model, the access point characteristic recognition module may perform a feature normalization and a feature reduction technique. After the application of the machine learning model, the detected access point characteristic is forwarded (210) to a report module (211).

The access point characteristic classification module applies a machine learning model that classifies an input into a class. The class refers to a group of given examples that present the same properties, i.e. AP characteristics. For example, a classifier may label an input as either software-based or hardware-based AP, in such a case the property is whether the AP is hardware-based device or software-based device. Before applying the machine learning module, the access point characteristic classification module translates the feature set to a proper machine learning input. As an example, the feature set translation may comprise none, all, or other of the following tasks: normalization, standardization, feature selection, feature reduction, among other pre-processing techniques. For instance, before applying a classifier machine learning model, the access point characteristic classification module may perform a feature reduction technique. After the application of the machine learning model, the labeled access point characteristic is forwarded (210) to a report module (211).

The report module goal is to gather all established access point characteristics and report them to the corresponding client. As an example, the client may be a wireless-based communication device, or a security solution.

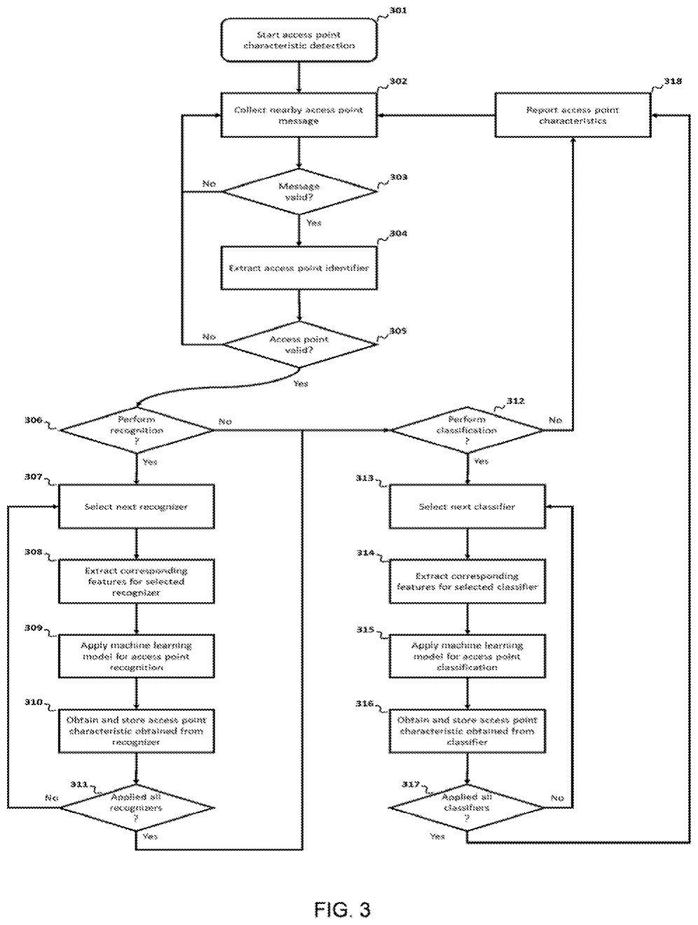

FIG. 3 illustrates the flowchart of the method of the present invention for detection of access point characteristics.

The initial access point characteristic detection is started (301) by a client query. As an example, the client may be a wireless-based communication device, or a security solution. Then, nearby Access Point messages are continuously collected (302). Therefore, when an access point message is received, its validity is verified (303). Valid messages are messages types from nearby access points that are used for classification and/or recognition purposes. If a valid message is found, the access point identifier is extracted (304). Examples of access point identifiers include but are not limited to SSID, BSSID, among others. Finally, if the message comes from a valid access point (305), the classification and/or recognition tasks can be performed. An access point is considered valid when its characteristics were still not detected by the present invention, or the client wishes to perform the detection again.

Valid access point messages undergo through a recognition and/or classification process. For the sake of simplicity, in the flowchart, such process is shown sequentially, in which the recognition is performed before the classification process. However, the invention may also be implemented to perform such tasks in parallel, or even in the opposite order, performing first the classification task then the recognition task.

If the recognition process is performed (306), it starts with the selection of a proper machine learning model from the recognizer (307). Proper recognizer's machine learning models are algorithms used for detecting access point characteristics that were not used before for the same access point identifier detection task. Therefore, each access point characteristics needs to be identified only once by the proposed invention. With the proper recognizer machine learning model, the corresponding set of features are selected (308). This process aims to building the feature set according to each recognizer machine learning model. This process occurs because each model may rely in a different feature set, established according to each model obtainment process. The corresponding set of features building process includes none, all, or some of the process of feature extraction, selection, normalization, standardization, reduction and/or any other preprocessing task needed to properly apply the recognizer machine learning model. Finally, the recognizer machine learning model is applied to the built feature set (309). The recognizer machine learning model outputs an access point characteristic, which is stored (310) until all recognizers and classifiers are applied. If all recognizers are applied, the classification process begins (311), otherwise the next recognizer is selected, and the process starts again.

If the classification process is going to be performed (312), a classifier is selected between a set of classifiers (313). Similar to the recognition process, a corresponding feature set is built for the selected classifier (314). The feature set building process includes none, all, or some of the process of feature extraction, selection, normalization, standardization, reduction and/or any other preprocessing task needed to properly apply the classifier machine learning model. With the classifier feature set properly built, the classifier can be applied for the detection of the access point characteristic (315). After applying the classifier machine learning model, its output, the access point characteristic, is stored until all classifiers are successfully applied (316). Finally, if all classifiers are applied, the report process can be performed; otherwise, the classification process is executed again, until all classifiers are applied (317).

The report of the access point characteristic is performed when all classifiers and/or recognizers are applied to the selected access point message (318). The report process starts with the gathering of all detected access point characteristics, obtained when applying the recognizers and/or classifiers. Afterwards, the obtained access point characteristics are reported to the client device, which started the detection process. Finally, after reporting the proper access point characteristic, the process starts over again, with the collection of nearby access point messages (302).

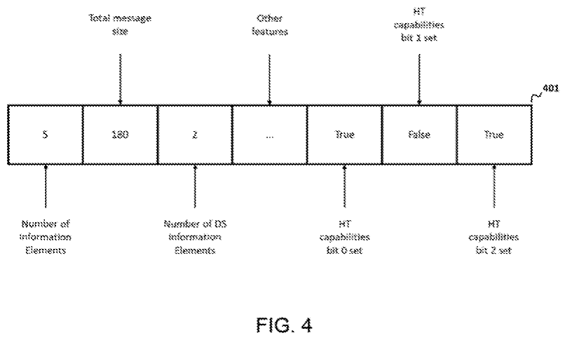

FIG. 4 shows an example of an extracted feature vector obtained after the feature extraction of an access point message (401). For the sake of simplicity, the IEEE 802.11 probe response message fields are used in the figure, however other access point messages can be used for the access point characteristics detection process. Examples of features that can be extracted from an IEEE 802.11 probe response message fields include but are not limited to number of information elements, total message size, number of DS information elements, HT capabilities bit 0 set, HT capabilities bit 1 set, HT capabilities bit 2 set, among others. Therefore, feature values can be obtained directly from the message field value, for example, HT capabilities bit 0 set, HT capabilities bit 1 set, HT capabilities bit 2 set, among others. In contrast, other feature values can only be obtained after a computational process, for example number of information elements, total message size, number of DS information elements, among others.

Although the present disclosure has been described in connection with certain preferred embodiments, it should be understood that it is not intended to limit the disclosure to those particular embodiments. Rather, it is intended to cover all alternatives, modifications and equivalents possible within the spirit and scope of the disclosure as defined by the appended claims.

What is claimed is:

1. A method for detecting access point characteristics using machine learning techniques, the method comprising:
collecting, by a wireless message sniffer module, access point messages to be used for recognition or classification purposes;
filtering, by a message filter module, a set of desired access point message types to be used for recognition or classification purposes;
extracting, by a feature extraction module, features from the access point messages to be used for recognition or classification purposes;
recognizing, by an access point characteristic recognition module, access point characteristics to be used for external solutions;
classifying, by an access point characteristic classification module, the access point characteristics to be used for external solutions.

2. The method of claim 1, wherein the collecting the access point messages to be used for recognition or classification purposes comprises:
collecting, by the wireless message sniffer module, messages exchanged in a wireless communication link.

3. The method of claim 1, wherein the filtering the set of desired access point message types to be used for recognition or classification purposes comprises:
identifying, by the message filter module, the set of messages types to be used for recognition or classification purposes;
filtering, by the message filter module, the access point messages collected by the wireless message sniffer module.

4. The method of claim 1, wherein the extracting the features from the access point messages to be used for recognition or classification purposes comprises:
determining, by the feature extractor module, the features to be extracted according to the machine learning model;
extracting, by the feature extractor module, the features according to the machine learning model;
preprocessing, by the feature extractor module, the extracted features according to the machine learning model.

5. The method of claim 1, wherein the recognizing the access point characteristics to be used for external solutions comprises:
applying, by the access point characteristic recognition module, a machine learning model for recognition of the access point characteristics;
determining, by the access point characteristic recognition module, the access point characteristics according to the applied machine learning model;
assembling, by the access point characteristic recognition module, the determined access point characteristics.

6. The method of claim 1, wherein the classifying the access point characteristics to be used for external solutions comprises:
applying, by the access point characteristic classification module, a machine learning model for classification of the access point characteristics;
determining, by the access point characteristic classification module, the access point characteristics according to the applied machine learning model;
assembling, by the access point characteristic classification module, the determined access point characteristics.

7. The method of claim 1,
wherein the access point characteristics are determined by applying a machine learning model for recognition purposes,
wherein the machine learning model is configured to receive the access point features and output the access point characteristics, and
wherein the machine learning model used for recognition is configured to determine the set of desired access point types.

8. The method of claim 1,
wherein the access point characteristics are determined by applying a machine learning model for classification purposes,
wherein the machine learning model is configured to receive the access point features and output the access point characteristics, and
wherein the machine learning model used for classification is configured to determine the set of desired access point types.

9. The method of claim 1, wherein the features from the access point messages are determined by applying a feature extraction process.

10. The method of claim 1, wherein the extracting the features from the access point messages to be used for recognition or classification purposes comprises:
receiving, by the feature extraction module, the access point messages, building the features by copying field values of the messages or performing further processing to build the features, and outputting the features from the access point messages.

11. The method of claim 1, wherein the access point messages used for the extracting the features are determined by a message filtering process.

12. The method of claim 1, wherein the filtering, by the message filter module, the set of desired access point message types to be used for recognition or classification purposes comprises:
receiving all messages collected in a wireless communication link and outputting the set of desired access point messages.

13. The method of claim 1, wherein the access point characteristics are passively determined.

14. The method of claim 1, wherein the access point messages are collected passively, without user intervention in the wireless communication link.

15. The method of claim 1, wherein at least a portion of the access point characteristics is determined by a user.

16. The method of claim 1, wherein the machine learning techniques include a set of machine learning models for recognition or classification purposes.
